(19) United States
(12) Patent Application Publication
(10) Pub. No.: US 2007/0011922 A1
(43) Pub. Date: Jan. 18, 2007

(54) Disposable cup and cup cover for advertisement

(76) Inventors: Chang-Fu Huang, Fremont, CA (US); Roger Huang, Fremont, CA (US)

Correspondence Address: Bo-In Lin, 13445 Mandoli Drive, Los Altos Hills, CA, 94022, US

(21) Appl. No.: 11/056,072

(22) Filed: Feb. 11, 2005

(51) Int. Cl. G09F 3/00

(52) U.S. Cl. 40/307; 40/324

(57) ABSTRACT

The present invention discloses a cup cover covering a cup that includes a thin film to seal a top opening of the cup. The cup cover includes an advertisement printed thereon. In a preferred embodiment, the advertisement printed on the thin film sealing the top opening of the cup further includes a special color commonly associated with a name brand for highlighting the advertisement for the name brand. In another preferred embodiment, the thin film for sealing the top opening of the cup further comprising a small breakable area for inserting a straw therein. In another preferred embodiment, the thin film for sealing the top opening of the cup further includes a pull up tap for pulling up the thin film for opening the top opening. In another preferred embodiment, the thin film for sealing the top opening of the cup further includes a pull up tap for pulling up a portion of the thin film to function as a drinking opening on the thin film.

### BACKGROUND OF THE INVENTION

1. Field of the Invention

This invention relates generally to the configuration and method for manufacturing a cup cover for providing advertisement thereon and a business model to gain profit therefrom. More particularly, this invention relates to an improved configuration for sealing cups with thin film cup covers with advertisement thereon and a business model for employing the improved cup covers for commercial gains.

2. Description of the Prior Art

As many large corporations and commercial enterprises spend large amount of moneys to promote different products and services by advertisements through various kinds of mass media channels such as TV, radios, and various sign post in public places to propagate the commercial messages to the consumers, yet there are other newly emerging market channels are still being ignored not properly developed. Specifically, rapid increase of daily consumptions of disposable cups provided with cup covers through widespread of coffee shops and various specialty drinking stores are still not being effectively exploited as a potential channel for advertisements. The use of disposable cups with covers are now spread everywhere from the fast food stores to street corner coffee shops to special drink shops in different shopping malls. Holding a disposable cup with a cover has become a daily routine for large number of people. Such widespread use of the disposable cups and disposable cup covers present special opportunity for effective advertisements. However, conventional methods and market channels still have not take advantage of the disposable cup and the cup cover as a platform for promotion of products or services.

In U.S. Patent Publication 20020108959, Wanda discloses a travel mug featuring an airtight, no leak, easy opening, automatic closing that includes a valve means to provide the benefit of ensuring no beverage emerges from the inside of the container unless the opening mechanism is activated. By using a special O-ring, the cover of the travel mug can sustain additional pressure of very hot coffee, and even when shaken, the sealing mechanism remains leak-proof. Wanda further discloses that a Cover Disk provides an ideal surface for logo or other advertisement, as the surface is presented to the user's vision each time user drinks from the invention. The cover disk also serves as support for the mechanisms. As Wanda briefly presented the concept of using the cup cover for the purpose of advertisement, the effectiveness of advertisement is very limited. Compared to the number daily consumptions of the disposable cups such as cups for holding cold drinks or coffee, the number of travel mugs have very limited number of sales. The targeted market for advertisement would limited only to the purchasers of the travel mug. The advertisement printed on the cover disk of the travel mug as disclosed by Wanda is probably not practical and cannot justify the cost for printing an advertisement logo on the cover disk other than the logo of the travel mug itself. Wanda's travel mug would not be a practical mass media for effective advertisement.

In another US Patent Publication 20030135409, Romano discloses a container enclosure that includes a tear away portion on the container representing a coupon, promotion, prize or other advertisement and a method for making the tear away portion as a coupon or advertisement. The cover includes a first layer, a second layer and a removable piece. The first layer is adapted to protectively shield and retain the product within the interior portion of the container. The second layer is adapted to overlay the first layer and further includes a weakened portion. The removable piece is adapted to be integrated with the second layer and may be separated from the second layer by breaking weakened scored portion and tearing away the removable piece from the second layer while leaving the first layer to retain the contents within the interior portion of the container. The removable piece may be used as a premium, coupon, prize or other type of advertisement. The container or the cover with coupon or advertisement of Romano would not provide effective mass media advertisement in and of itself due to the lack of visibility of such coupon or advertisements. Only those who are interested in the coupon are attracted to purchase the product. The effectiveness of advertisement is still quite limited.

Therefore, a need still exists in the art of manufacture and sales of cup cover for sealing a cup to provide and establish an advertisement platform to take full advantage of the widespread use of disposable cup and its covers by large number of consumers in modern marketplace.

### SUMMARY OF THE PRESENT INVENTION

It is therefore an object of the present invention to provide a cup cover as a thin film sealed the top opening of the cup with messages and graphic images as an advertisement printed on the top surface of the cup cover whereby an advertising message may be effectively propagated through the consumer channels using the disposable cups.

Specifically, it is further an object of the present invention to provide a new business model to economically distribute the cup covers to large number of drinking shops taking advantage of the mass produced cup cover machine such that effective and rapid spread of advertisement messages can be achieved because of the market enhancement induced by an effective business model that provides economic incentive to use the cup covers at greatly reduce cost.

Briefly, in a preferred embodiment, the present invention discloses a cup cover covering a cup that includes a thin film to seal a top opening of the cup. The cup cover includes an advertisement printed thereon. In a preferred embodiment, the advertisement printed on the thin film sealing the top opening of the cup further includes a special color commonly associated with a name brand for highlighting the advertisement for the name brand. In another preferred embodiment, the thin film for sealing the top opening of the cup is a fully breakable area for inserting a straw therein.

In another preferred embodiment, the thin film for sealing the top opening of the cup further includes a pull up tap for pulling up the thin film for opening the top opening. In another preferred embodiment, the thin film for sealing the top opening of the cup further includes a pull up tap for pulling up a portion of the thin film to function as a drinking opening on the thin film.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is a perspective view of a cup sealed with a thin film cup cover and the thin film cup cover is printed with advertisement messages thereon;

FIGS. 1A to 1F are samples of advertisements printed on the thin film for sealing the top opening of a disposable cup of FIG. 1;

FIG. 2 is a perspective view of a roll of thin film with thin film printed with advertisement and each of thin film is then sealed onto a cup of FIG. 1 using a mass productive cup-sealing machine which is commercially available;

FIG. 3 is a perspective view of a thin film sealing machine for sealing the disposable cup of FIG. 1 using the thin film rolls of FIG. 2A to automatically seal the cup at a very high speed operation of more than four hundred cups an hour;

FIG. 4 is a flowchart for illustrating a business model of this invention to promote and rapidly increase the sales of the thin film cup cover to shops for selling drinks;

### DETAILED DESCRIPTION OF THE PREFERRED EMBODIMENT

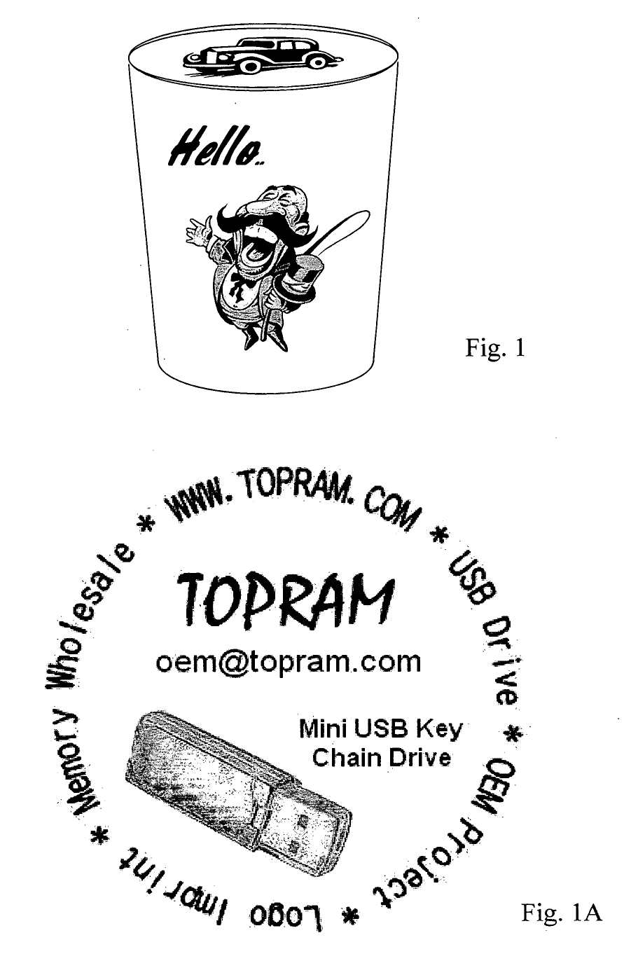

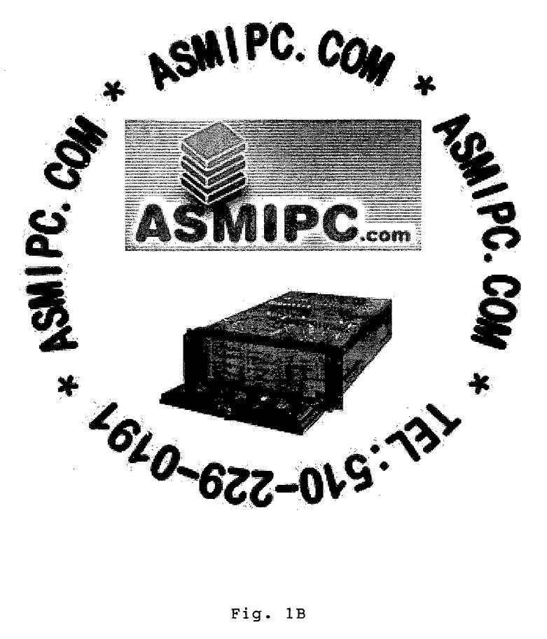

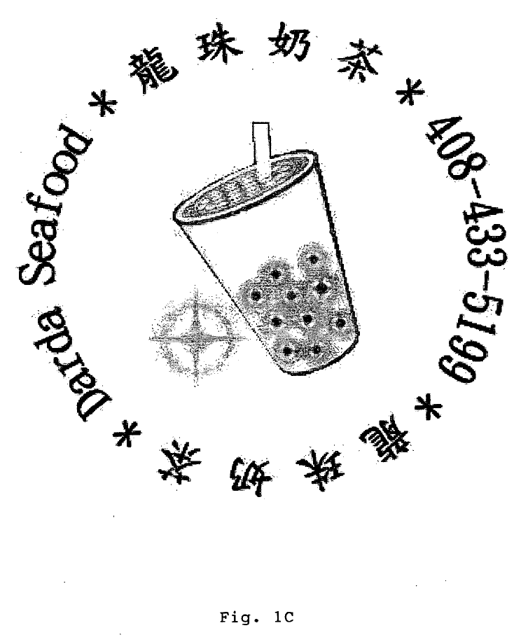

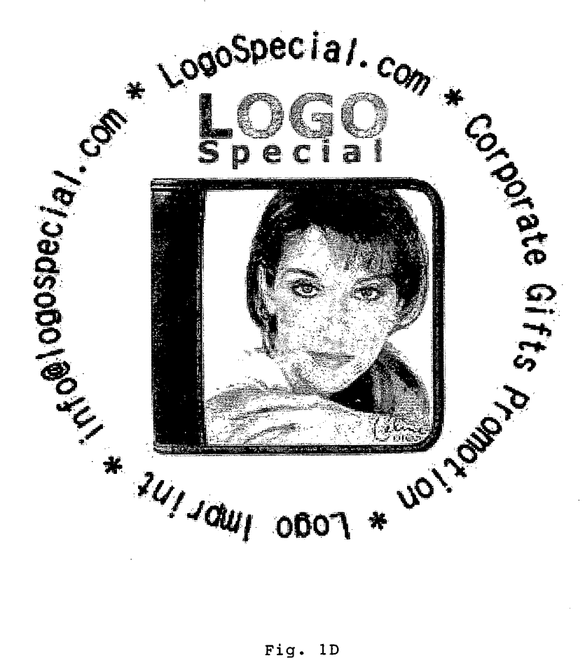

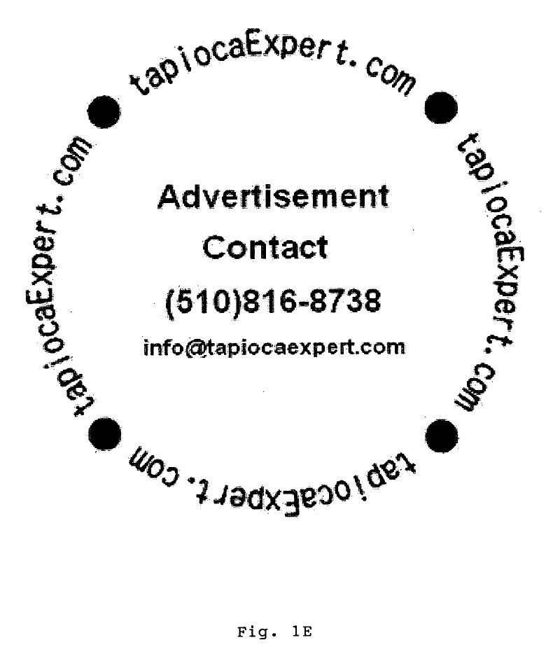

FIG. 1 is a perspective view of a disposable cup 100 for containing liquid drink therein. The cup 100 has a top opening that is covered by a thin film 110 sealing the top opening thus preventing the liquid contained in the cup to leak or spill out from the cup. The thin film 110 that seals the top opening is further printed with graphic advertisement message thereon for promoting a particular goods or services that would probably of interest to the consumers who purchased the drinks containing in the sealed disposable cup 100. FIGS. 1A to 1F are samples of advertisement printed on the thin film for covering and sealing a disposable cup for containing a drink therein.

According to FIG. 1, this invention discloses a cup cover covering a cup that includes a thin film sealing a top opening of the cup further includes an advertisement printed thereon. In a preferred embodiment, the advertisement printed on the thin film sealing the top opening of the cup further includes a special color commonly associated with a name brand for highlighting the advertisement for the name brand. In another preferred embodiment, the thin film for sealing the top opening of the cup further includes a small breakable area for inserting a straw therein. In another preferred embodiment, the thin film for sealing the top opening of the cup further comprises a pull up tap for pulling up the thin film for opening the top opening. In another preferred embodiment, the thin film for sealing the top opening of the cup further comprises a pull up tap for pulling up a portion of the thin film to function as a drinking opening on the thin film. In another preferred embodiment, the advertisement printed on the thin film sealing the top opening of the cup further includes a special flashing light emitting elements for highlighting the advertisement. In another preferred embodiment, the advertisement printed on the thin film sealing the top opening of the cup further includes a translucent element for emitting light for highlighting the advertisement. In another preferred embodiment, the advertisement printed on the thin film sealing the top opening of the cup further includes an element for emitting visible light in darkness for highlighting the advertisement. In another preferred embodiment, the advertisement printed on the thin film sealing the top opening of the cup further includes an Universal Resource Location (URL) for linking to an Internet Website printed thereon.

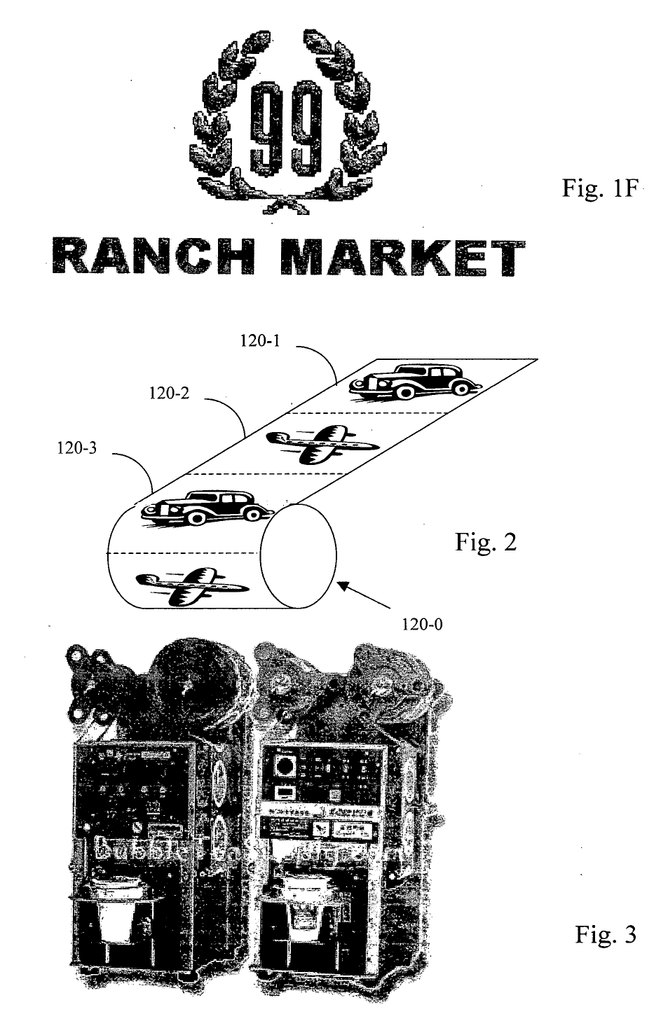

FIG. 2 shows a roll that comprises a sheet having a plurality of thin films 110. Each of these thin films is printed with an advertisement message thereon and the advertisements as that printed on these thin films may be advertisements for either different or same products or services. This roll of sheet with a plurality of thin films 110 may be used by a cup sealing machine, e.g., cup sealing machine model TE-100, as that shown in FIG. 3 for automatically sealing the disposable cup 100. For special advertisement effect, the thin films 110 for sealing the cup 100 may be of special color to create a visual effect that is associated with a particular good or service.

According to above descriptions, this invention further discloses a method for distributing an advertisement that includes a step of printing an advertisement on a thin film and sealing a cup with the thin film as a cup cover for containing and selling a drink contained in the cup. In a preferred embodiment, the step of printing the advertisement further includes a step of printing the advertisement with a special color commonly associated with a name-brand for highlighting the advertisement for the name-brand. In another preferred embodiment, the step of printing the advertisement on the thin film further includes a step of sealing the top opening of the cup by providing a small breakable area on the thin film for inserting a straw therein. In a preferred embodiment, the step of printing the advertisement on the thin film further includes a step of providing a pull up tap on the thin film for pulling up the thin film for opening the cup cover sealing the cup. In another preferred embodiment, the step of printing the advertisement on the thin film further includes a step of providing a special flashing light emitting elements for highlighting the advertisement. In another preferred embodiment, the step of printing the advertisement on the thin film further includes a step of deposing a translucent element on the thin film for emitting light for highlighting the advertisement In another preferred embodiment, the step of printing the advertisement on the thin film further includes a step of deposing an element for emitting visible light in darkness on the thin film for highlighting the advertisement. In another preferred embodiment, the step of printing the advertisement on the thin film further includes a step of printing an Universal Resource Location (URL) for linking to an Internet Website.

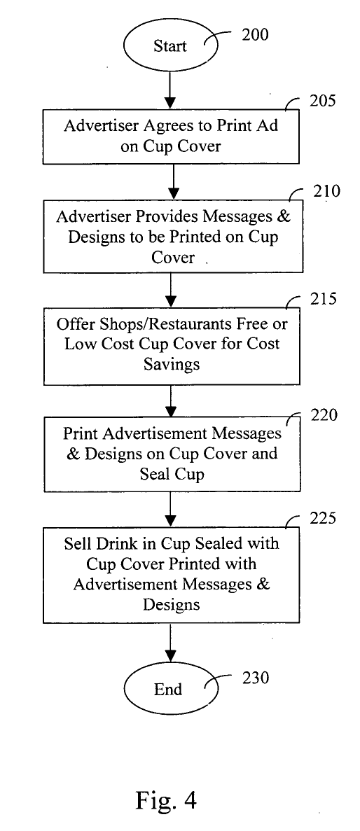

FIG. 4 is a flowchart for showing a business model to create a business incentive to rapidly distribute the thin film cup cover to different kinds of drink shops or fast food chains such that the advertisement effects may be spread more quickly. The process starts (step 200) with a step of signing a contract with an advertiser for an agreement to print the advertisement on the cup cover (step 205). The advertiser then provides the advertisement messages and designs to print on the cup cover (step 210) followed by an offer to various drink shops or drink suppliers either free cup covers or cup covers with much reduced price (step 215) such that the drink shops or drink suppliers are willing to use these cup covers. The advertisement messages and designs are printed on cup cover, e.g., the thin films for sealing the cups (step 220). The cup cover is probably also printed with marks of the drink shops or drink suppliers and the kind of drink contained in the cup. Then the cup sealed with the cup cover printed with advertisement messages and designs are sold to consumers who consume the drinks and in the meantime the advertised messages are spread through the market channel of the sales of these drinks contained in the cup covered with the cup covers of this invention (step 225) and the processes of enhancing the effectiveness of the advertisement using the cup cover is ended (step 230).

According to FIG. 4 and above descriptions, this invention discloses a method of distributing an advertisement printed on a plurality of cup covers for covering a plurality of cups. The method includes a step of selling the cup covers to a plurality of shops and cup makers at a significantly reduced price for covering the plurality of cups with the advertisement printed the cup covers for selling a drink contained in the cups and also distributing the advertisement. In another preferred embodiment, the method further includes a step of rolling a plurality of thin film cup covers into a plurality of cup cover rolls and selling the cup cover rolls to the plurality of shops and cup makers at a significantly reduced price for covering the thin film cup cover printed with the advertisement on the plurality of cups for selling a drink contained in the cups. In another preferred embodiment, the method further includes a step of printing several kinds of advertisements on a plurality of thin film cup covers and rolling the plurality of thin film cup covers into a plurality of cup cover rolls and selling the cup cover rolls to the plurality of shops and cup makers at a significantly reduced price for covering the cup cover printed with the several kinds of advertisements on a plurality of cups for selling a drink contained in the cups. In another preferred embodiment, the method further includes a. step of selling/leasing a plurality of high-speed automatic cup-sealing machine to a plurality of shops and cup makers at a significantly reduced price for using the cup covers for covering the plurality of cups with the advertisement printed thereon for selling a drink contained in the cups and also distributing the advertisement.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A cup cover covering a cup comprising:
a thin film sealing a top opening of said cup further comprising an advertisement printed thereon.

2. The cup cover for covering a cup of claim 1 wherein:
said advertisement printed on said thin film sealing said top opening of said cup further comprising a special color commonly associated with a name-brand for highlighting said advertisement for said name-brand.

3. The cup cover for covering a cup of claim 1 wherein:
said thin film for sealing said top opening of said cup further comprising a small breakable area for inserting a straw therein.

4. The cup cover for covering a cup of claim 1 wherein:
said thin film for sealing said top opening of said cup further comprising a pull up tap for pulling up said thin film for opening said top opening.

5. The cup cover for covering a cup of claim 1 wherein:
said thin film for sealing said top opening of said cup further comprising a pull up tap for pulling up a portion of said thin film to function as a drinking opening on said thin film.

6. The cup cover for covering a cup of claim 1 wherein:
said advertisement printed on said thin film sealing said top opening of said cup further comprising a special flashing light emitting elements for highlighting said advertisement.

7. The cup cover for covering a cup of claim 1 wherein:
said advertisement printed on said thin film sealing said top opening of said cup further comprising a translucent element for emitting light for highlighting said advertisement.

8. The cup cover for covering a cup of claim 1 wherein:
said advertisement printed on said thin film sealing said top opening of said cup further comprising an element for emitting visible light in darkness for highlighting said advertisement.

9. The cup cover for covering a cup of claim 1 wherein:
said advertisement printed on said thin film sealing said top opening of said cup further comprising an Universal Resource Location (URL) for linking to an Internet Website printed thereon.

10. A method for distributing an advertisement comprising:
printing an advertisement on a thin film and sealing a cup with said thin film as a cup cover for containing and selling a drink contained in said cup.

11. The method of claim 10 wherein:
said step of printing said advertisement further comprising a step of printing said advertisement with a special color commonly associated with a name-brand for highlighting said advertisement for said name-brand.

12. The method of claim 10 wherein:
said step of printing said advertisement on said thin film further comprising a step of sealing said top opening of said cup by providing a small breakable area on said thin film for inserting a straw therein.

13. The method of claim 10 wherein:
said step of printing said advertisement on said thin film further comprising a step of providing a pull up tap on said thin film for pulling up said thin film for opening said cup cover sealing said cup.

14. The method of claim 10 wherein:
said step of printing said advertisement on said thin film further comprising a step of providing a special flashing light emitting elements for highlighting said advertisement.

15. The method of claim 10 wherein:
said step of printing said advertisement on said thin film further comprising a step of deposing a translucent element on said thin film for emitting light for highlighting said advertisement.

16. The method of claim 10 wherein:
said step of printing said advertisement on said thin film further comprising a step of deposing an element for emitting visible light in darkness on said thin film for highlighting said advertisement.

17. The method of claim 10 wherein:
said step of printing said advertisement on said thin film further comprising a step of printing an Universal Resource Location (URL) for linking to an Internet Website.

18. A method of distributing an advertisement printed on a plurality of cup covers for covering a plurality of cups comprising:
selling said cup covers to a plurality of shops and cup makers at a significantly reduced price for covering said plurality of cups with said advertisement printed said cup covers for selling a drink contained in said cups and also distributing said advertisement.

19. The method of claim 18 further comprising:
rolling a plurality of thin film cup covers into a plurality of cup cover rolls and selling said cup cover rolls to said plurality of shops and cup makers at a significantly reduced price for covering said thin film cup cover printed with said advertisement on said plurality of cups for selling a drink contained in said cups.

20. The method of claim 18 further comprising:
printing several kinds of advertisements on a plurality of thin film cup covers and rolling said plurality of thin film cup covers into a plurality of cup cover rolls and selling said cup cover rolls to said plurality of shops and cup makers at a significantly reduced price for covering said cup cover printed with said several kinds of advertisements on a plurality of cups for selling a drink contained in said cups.

21. The method of claim 18 further comprising:
selling/leasing a plurality of high-speed automatic cup-sealing machine to a plurality of shops and cup makers at a significantly reduced price for using said cup covers for covering said plurality of cups with said advertisement printed thereon for selling a drink contained in said cups and also distributing said advertisement.
